(19) United States
(12) Patent Application Publication
(10) Pub. No.: US 2005/0218047 A1
(43) Pub. Date: Oct. 6, 2005

(54) Fluid treatment system

(75) Inventors: Roy M. Taylor JR., Rockford, MI (US); William T. Stoner JR., Ada, MI (US)

Correspondence Address: ALTICOR INC., 7575 FULTON STREET EAST MAILCODE 78-2G, ADA, MI, 49355, US

(73) Assignee: Access Business Group International LLC

(21) Appl. No.: 11/094,739

(22) Filed: Mar. 30, 2005

Related U.S. Application Data
(60) Provisional application No. 60/558,223, filed on Mar. 31, 2004.

(51) Int. Cl. B01D 35/14

(52) U.S. Cl. 210/85; 210/120; 210/436; 210/138; 210/137

(57) ABSTRACT

The disclosed embodiment of the present invention provides a vented water treatment system. According to one embodiment, the vent substantially equalizes pressure within the water treatment with ambient pressure, while preventing moisture and other contaminants from entering the water treatment system housing.

### RELATED APPLICATIONS

This application claims priority to and benefit of U.S. Provisional Application No. 60/558,223, entitled Vented Water Treatment System, by Roy M. Taylor Jr. et al., filed Mar. 31, 2004. The full disclosure of the prior application is incorporated herein by reference. This application hereby incorporates in its entirety by reference issued U.S. Pat. No. 5,344,558 entitled “Water Filter Cartridge”. This application also incorporates in their entirety U.S. patent application Ser. No. 10/966,771 entitled Diverter Valve Assembly, by Steve O. Mork et al., and filed Oct. 15, 2004, and U.S. patent application Ser. No. 10/140,123 entitled Water Filter Assembly, by Karen O. Vanderkooi et al., and filed May 6, 2002.

### TECHNICAL FIELD

The present invention relates to a fluid treatment system used to filter contaminants from a fluid supply.

### BACKGROUND OF THE INVENTION

The present invention minimizes or overcomes several problems associated with previous fluid treatment systems, and in particular, with fluid treatment systems used to treat fluid of varying temperatures. These fluid treatment systems often include a filter used to remove contaminants from the water, or a source of electromagnetic radiation such as an ultra-violet lamp (UV lamp) used to kill or inactivate organisms in the water, or both. In addition, these fluid treatment systems may contain electronic circuitry used to monitor and control a UV lamp, monitor the time that the fluid treatment system is in service, track the volume of water treated by the fluid treatment system, provide information to the user, or otherwise control or interact with the fluid treatment system. Typically, the electronic circuits or components are located within a housing or chamber that is not in fluid communication with the fluid being treated by the fluid treatment system. The interior of these housings or chambers are subjected to varying internal pressures caused by thermal cycling. For example, as a fluid treatment system treats hot fluid, the fluid treatment system warms, and the barometric pressure of the gas inside the fluid treatment system will increase roughly in proportion to the increase in temperature. During this period of increased barometric pressure, the seals and gaskets of the fluid treatment system may be breached, thus allowing the gas within the external housing to escape. During a subsequent cool cycle, or as the fluid treatment system cools when not in use, the barometric pressure of the gasses within the fluid treatment system is reduced, again roughly in proportion to the decrease in temperature. However, since gas escaped during the warming cycle, a slight vacuum may be formed within the fluid treatment system in relation to the ambient pressure. This vacuum may cause gasses surrounding the fluid treatment system to flowing into the fluid treatment system, carrying contaminants and moisture which may damage moisture sensitive components within the fluid treatment system.

### SUMMARY OF THE INVENTION

The disclosed embodiment of the present invention provides a fluid treatment system adapted for treating fluid of varying temperatures. According to one embodiment, the fluid treatment system is comprised of one or more pressure vents, wherein the one or more pressure vents substantially equalized pressure within one or more sections or chambers within the fluid treatment system and ambient pressure, while preventing moisture from entering those sections or chambers of the fluid treatment system.

### BRIEF DESCRIPTION OF THE DRAWINGS

FIG. 1 is a front perspective view of a water treatment system unit.

FIG. 2 is a rear perspective view of a water treatment system unit.

FIG. 3 is an exploded view of a water treatment system.

FIG. 4 is an exploded view of a water treatment system top housing.

FIG. 5 shows one embodiment of a battery housing.

FIG. 6 is an exploded of one embodiment of a diverter valve.

FIG. 7 is a sectional view of one embodiment of a diverter valve.

FIG. 8 shows one embodiment of a stationary disk.

FIG. 9 shows one embodiment of a movable disk.

FIG. 10 shows one embodiment of a valve stem.

FIG. 11 shows one embodiment of a seal.

FIG. 12 shows one embodiment of a retainer.

FIG. 13 is a sectional view of one embodiment of a vent installed in a water treatment system.

### DETAILED DESCRIPTION OF THE ILLUSTRATED EMBODIMENT

The present invention is not limited in its application to the details of construction and arrangement of parts as illustrated in the accompanying drawings and specifications. For purposes of disclosure, the illustrated embodiments will be described in connection with a point-of-use water treatment system (WTS), and more specifically in connection with a bath WTS that relies on one or more carbon-based filters to filter particulates and remove certain contaminants from water. Although described in connection with this particular application, one skilled in the art would recognize that the present invention is capable of being practiced in various ways within the scope of the disclosure.

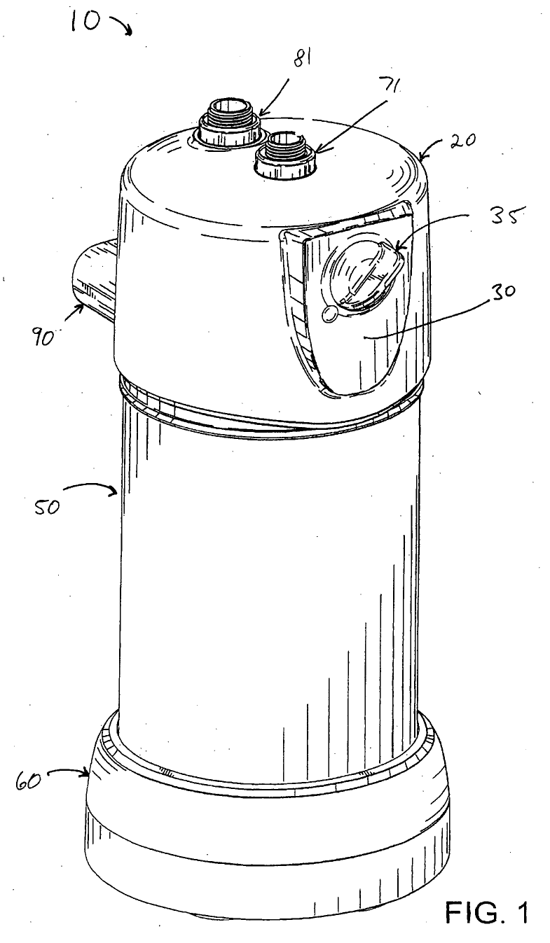

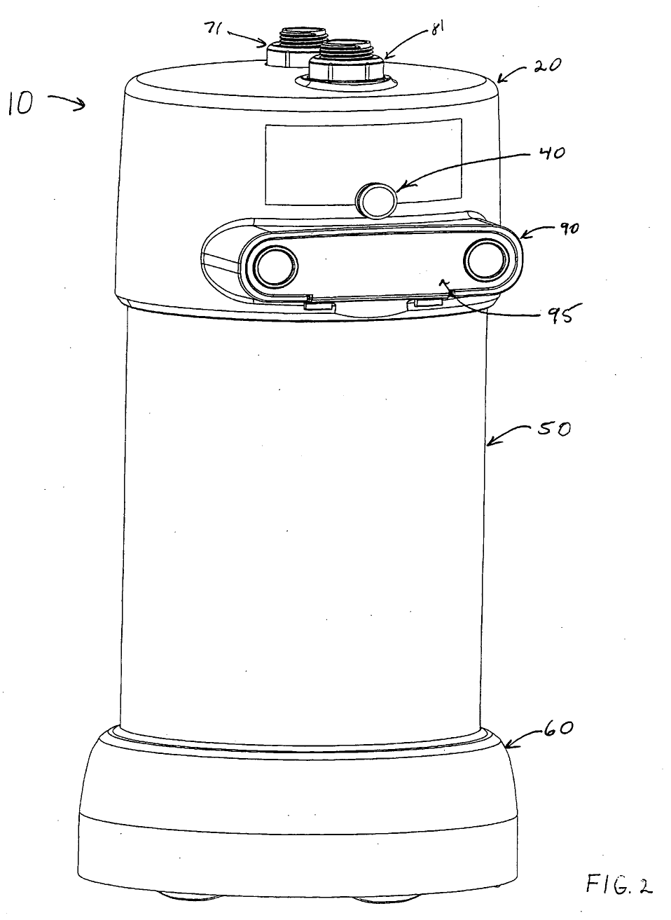

Referring to the figures, and in particular, FIGS. 1 and 2, one embodiment of the water treatment system (WTS) 10 is comprised of top housing 20, sleeve 50, base 60, control panel 30, knob 35, top housing vent 40, outlet nut 71, and inlet nut 81. Top housing 20 is further comprised of battery housing 90, and battery door 95.

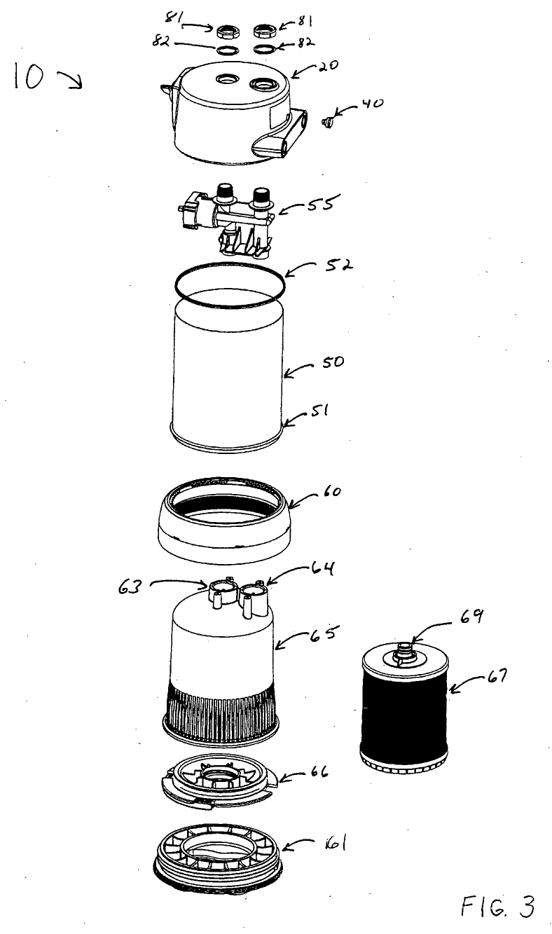

Referring to the figures, and in particular FIG. 3, WTS 10 is further comprised of overcap 61, filter 67, filter housing 65, filter housing base 66, seal 52, and valve 55. Filter housing 65 is further comprised of inlet orifice 64 and outlet orifice 63. Sleeve 50 is further comprised of sleeve lip 51. Filter 67 is adapted for insertion into filter housing 65 as described in more detail below. According to the illustrated embodiment, filter 67 is comprised of a generally cylindrically shaped carbon block filter, and filter outlet 69. One example of a carbon filter adapted for use in the illustrated embodiment is disclosed in U.S. patent publication 2003/0205518 entitled “Water Filter Assembly” to Vanderkooi et al., the subject matter of which is hereby incorporated in its entirety by reference.

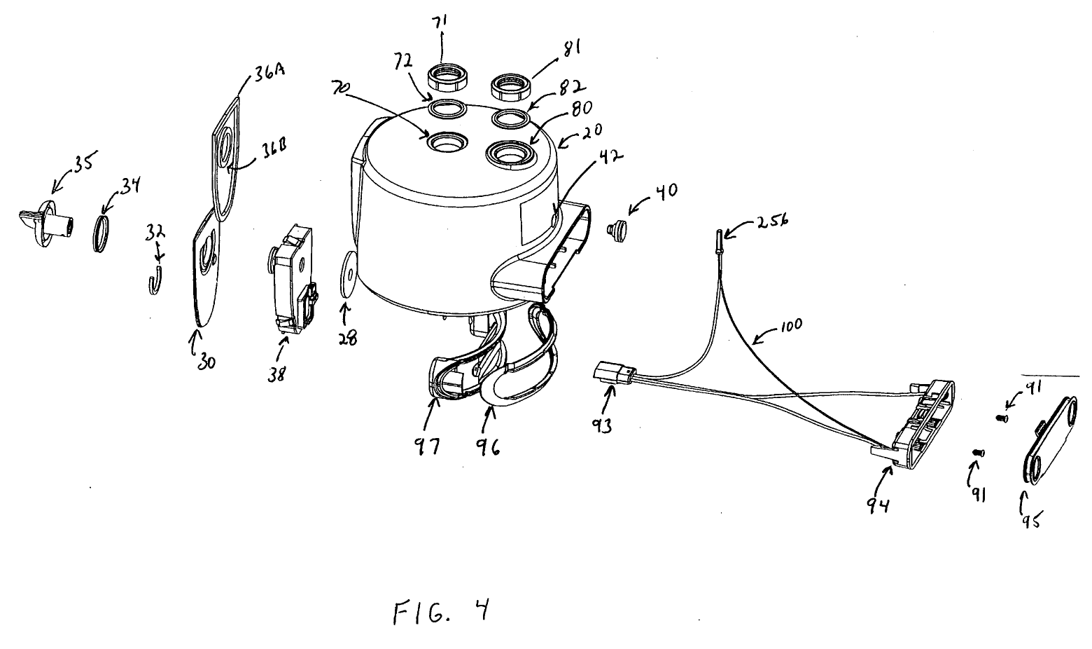

Referring to FIG. 4, top housing 20 is comprised of a generally cylindrically shaped wall with a closed end, and defining a hollow volume. Top housing 20 is further comprised of housing outlet orifice 70 and housing inlet orifice 80, as described in more detail below. Top housing 20 is further comprised of knob 35, knob seal 34, c-clip 32, control panel 30, gaskets 36 A/B, electronic module 38, gasket 28, vent orifice 42, outlet gasket 72 and outlet gasket 82, battery bracket 94, battery bracket base 97, battery bracket gasket 96, and electrical wiring harness 100. Wiring harness 100 is adapted to electrically couple with one or more batteries or other charge storage devices (not shown) within battery housing 90 with electrical connector 93 and flow meter sensor 256 as described in more detail below.

Electronics module 38 is adapted to monitor and display information regarding WTS 10. For example, electronics module 38 may be comprised of a timer circuit adapted to monitor the amount of time that WTS 10 is in service, and provide an audible or visual indication after the elapse of a predetermined amount of time. Similarly, electronics module 38 could monitor the amount of water that has been treated by WTS 10, as described in more detail below, and provide an audible or visual indication to the user when filter 67 has approached or reached its end-of-life.

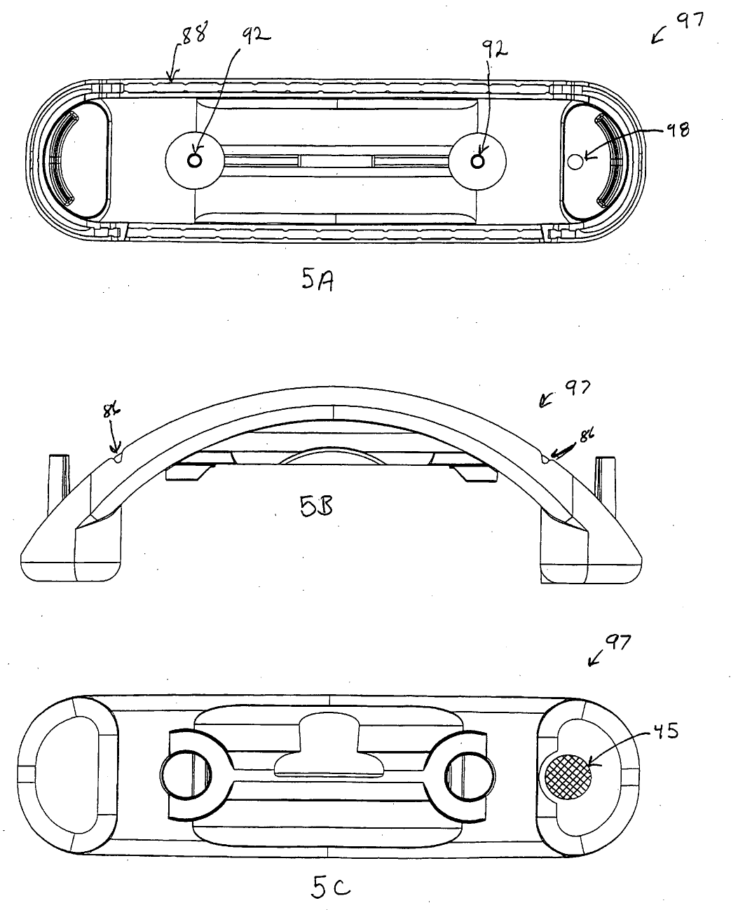

Referring to FIGS. 5A, 5B, and 5C provide respectively a front, top, and rear view of battery housing 97. According to the illustrated embodiment, battery housing 97 is comprised of battery housing vent orifice 98, battery housing vent 45, one or more wiring channels 86, and screw holes 92. Battery housing vent 45 of the illustrated embodiment is comprised of a microporous flouropolymer membrane, in the form of a disk, with an adhesive at the peripheral edge. The microporous flouropolymer membrane allows gasses to readily pass, while the surface tension of water prevents water from passing through the membrane. Battery housing vent 45 also inhibits the passage of contaminants such as dirt and dust through battery housing vent orifice 98. One example of a battery housing vent suitable for use with WTS 10 is vent VE 40510 manufactured by W.L. Gore and Associates of Newark, Del. Those skilled in the art would recognize that other membranes that are pervious to gas, but impervious to fluids, would function equivalently.

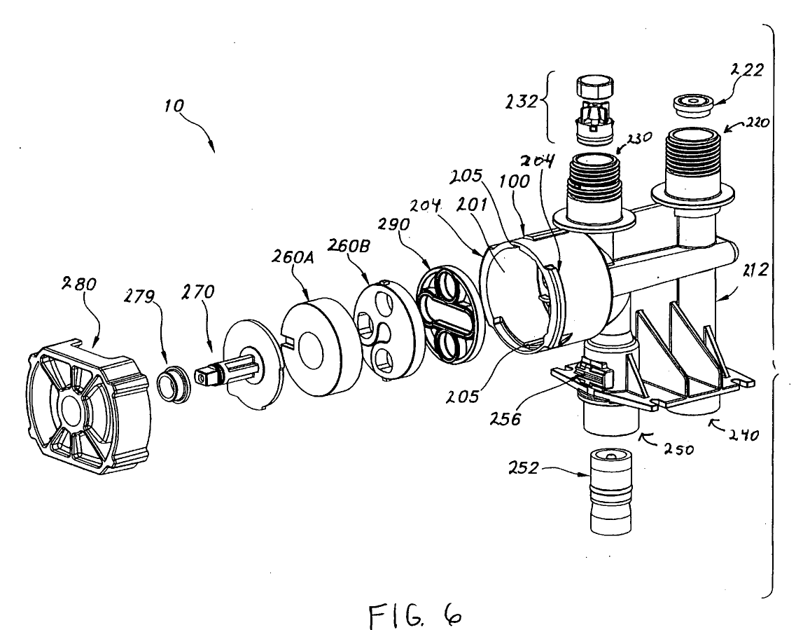

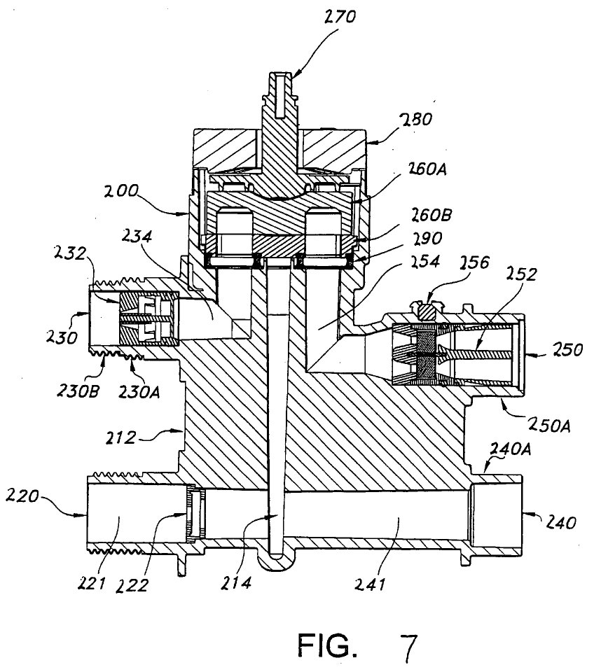

Referring to FIGS. 6 and 7, one example of valve 55 that can be used with the illustrated embodiment of WTS 10 is comprised of valve body 212, valve stem 270, and retainer 280. Valve body 212 is further comprised of primary inlet 220, primary outlet 230, secondary outlet 240, secondary inlet 250, and valve housing 200. Valve 55 is further comprised of stationary disk 260B, movable disk 260A, and seal 290, each of which is described in more detail below.

Valve body 212 is further comprised of valve chamber 201, shoulders 204, passage 214, primary inlet channel 221, primary outlet channel 234, secondary outlet channel 241, and secondary inlet channel 254. Passage 214 is in fluid communication with primary inlet 220 and secondary outlet 240 through primary inlet channel 221 and secondary outlet channel 241 respectively. Passage 214 is selectively in fluid communication with primary outlet 230 through primary outlet channel 234 as described in more detail below. Valve chamber 201 is further comprised of one or more slots 205.

Valve body 212 is typically injection molded, and is comprised of a high pressure, high temperature isoplast by Dow Chemical Company, although one skilled in the art would recognize that other manufacturing materials and processes would be equally suitable for the manufacture of valve body 212.

Exterior surface 240A of secondary outlet 240, and exterior surface 250A of secondary inlet 250 of the illustrated embodiment are manufactured without flash, ridges, “party lines”, or other artifacts caused by a seam between mold pieces of valve body 212. This is accomplished by inserting a pipe or other tubular device (not shown) into the mold recesses corresponding to the exterior surfaces 240A and 250A of apertures 240 and 250 either before, during, or after the injection of isoplast into valve body 212 mold (not shown). The pipe or other tubular device is not attached or fixed to exterior surfaces 240A and 250A.

Optionally disposed entirely within primary inlet channel 221 is flow regulator 222. Flow regulator 222 regulates the flow of fluid through valve 55 as described in more detail below. Optionally disposed entirely within secondary inlet channel 254 is flow meter 252. Mounted on valve body 212 proximate to flow meter 252, is flow meter sensor 256. Flow meter 252 and flow meter sensor 256 are operative to monitor flow of fluid through diverter valve assembly 210 as described in more detail below. It would be obvious to those skilled in the art that flow meter 252 could also be alternatively disposed within one or more of primary inlet channel 221, primary outlet channel 234, or secondary outlet channel 241, with flow meter sensor 256 located proximate to flow meter 252. Optionally disposed entirely within primary outlet channel 234 is check valve 232. Check valve 232 is operative to prevent the reverse flow of fluid through valve 55, as described below in more detail.

The exterior of primary outlet 230 is optionally comprised of a threaded section 230A and threaded section 230B. According to the present embodiment, threaded section 230B has a smaller outside diameter than threaded section 230A. The two distinct threaded sections allow valve 55 to be removably attached to top housing 20 by inserting primary outlet 230 through outlet orifice 70 and threading nut 71 on threaded section 230A, with outlet gasket 72 interposed between nut 71 and top housing 20. Threaded section 230B remains exposed, allowing a user to couple a fluid fixture with primary outlet 230.

Primary inlet 220 of the illustrated embodiment is adapted to be coupled with a fluid supply system, such as a water pipe, hose, vessel, or any other fluid supply system known in the art. Primary outlet 230 of the illustrated embodiment is adapted to be coupled with a fluid fixture, such as a faucet, shower head, tap, spout, spigot, or any other fluid fixture known in the art. Herein, the phrase “coupled with” is defined to mean directly connected to or indirectly connected through one or more intermediate components. Such intermediate components may include piping, hose, tubing, fittings, couplings, or any combination thereof.

Secondary outlet 240 is adapted to be coupled with inlet orifice 64 of filter housing 65. Secondary inlet 250 is adapted to be coupled with outlet orifice 63 of filter housing 65.

It is obvious to those skilled in the art that many valve assemblies are suitable for use with the illustrated embodiment of the present invention. One example of a valve assembly suitable for use with the illustrated embodiment of the present invention is disclosed in pending U.S. patent application Ser. No. 10/966,771 entitled “Diverter Valve Assembly” to Mork, et al., The subject matter of which is hereby incorporated in its entirety by reference. It would also be obvious to those skilled in the art that valve 55 could be located outside of WTS 10, or that WTS 10 could be adapted for use without valve 55.

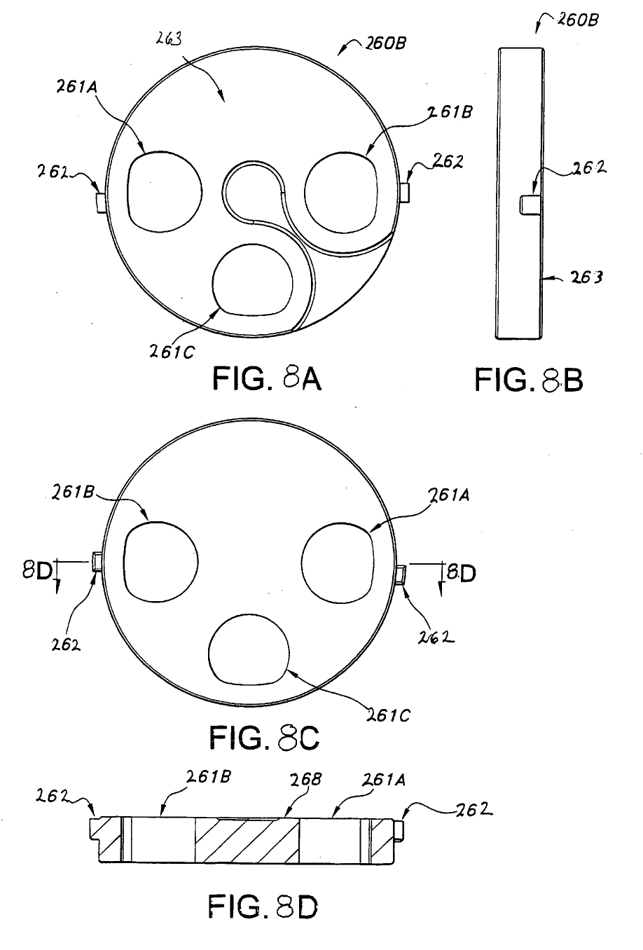

FIGS. 8A, 8B, 8C and 8D provide respectively a top, side, bottom, and sectional view of stationary disk 260B. According to the illustrated embodiment, stationary disk 260B is comprised of a 96% alumina ceramic, such as Hilox 965 by Ceramtec AG, although one skilled in the art would recognize that other materials would be equally for stationary disk 260B. Stationary disk 260B is further of comprised of a plurality of tabs 262, circular apertures 261A-C, and top surface 263.

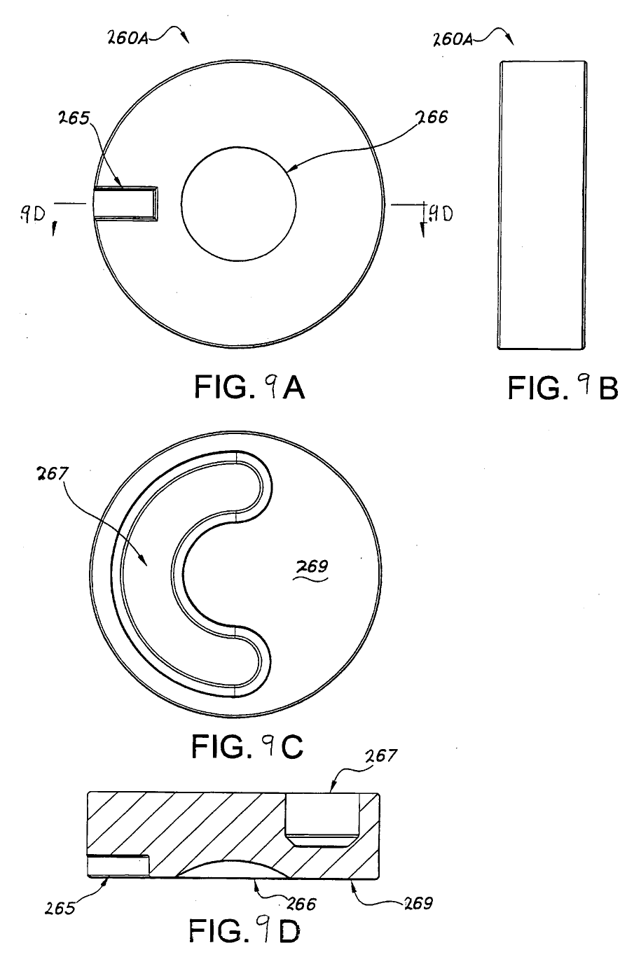

FIGS. 9A, 9B, 9C, and 9D provide respectively a top, side, bottom, and sectional view of movable disk 260A. According to the illustrated embodiment, movable disk 260A is comprised of a 96% alumina ceramic, such as Hilox 965 by Ceramtec AG, although one skilled in the art would recognize that other materials would be equally for movable disk 260A. Movable disk 260A is further comprised of slot 265, circular recess 266, “C”-shaped recess 267 and bottom surface 269.

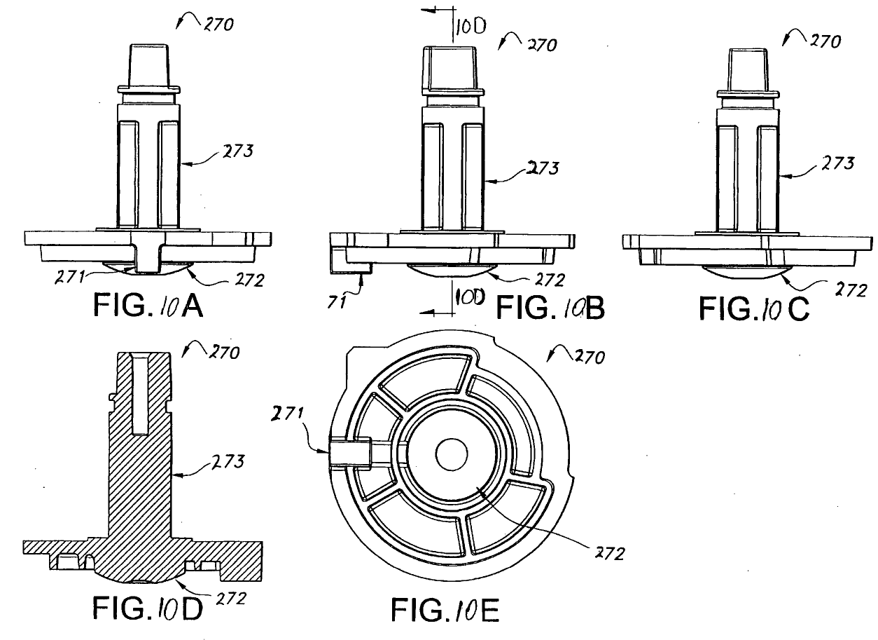

FIGS. 10A, 10B, 10C, 10D, and 10E provide respectively a front, left side, rear, sectional and bottom view of valve stem 270. Valve stem 270 is comprised of a polymer such as Acetal M90, although one skilled in the art would recognize that other materials would be equally for valve stem 270. Valve stem 270 is further comprised of tab 271, protuberance 272, and shaft 273.

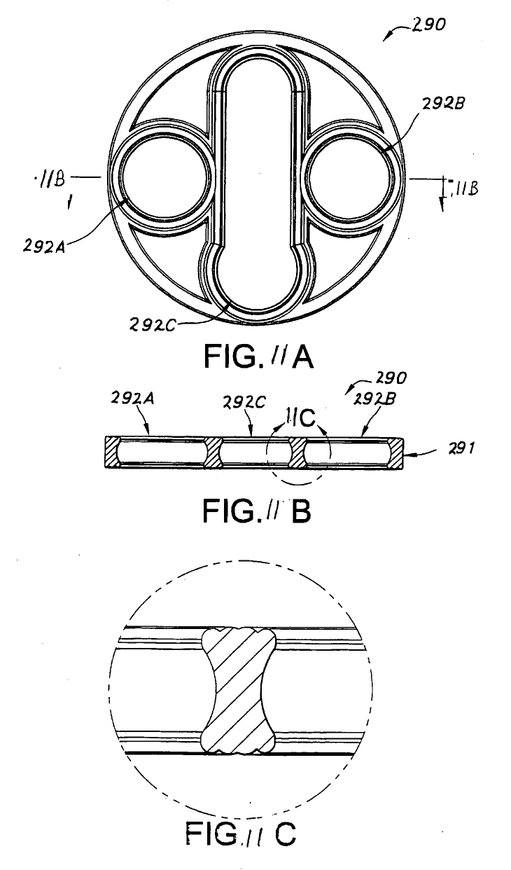

FIGS. 11A, 11B, and 11C provide respectively a top, sectional, and detail view of seal 290. According to the illustrated embodiment, seal 290 is comprised of silicone, although one skilled in the art would recognize that other materials would be equally for seal 290. Seal 290 is further comprised of outer surface 291, and circular apertures 292A and 292B, and generally oval aperture 292C. FIG. 10C provides a detail of the cross section of seal 290 between apertures 292A and 292C, and between 292B and 292C.

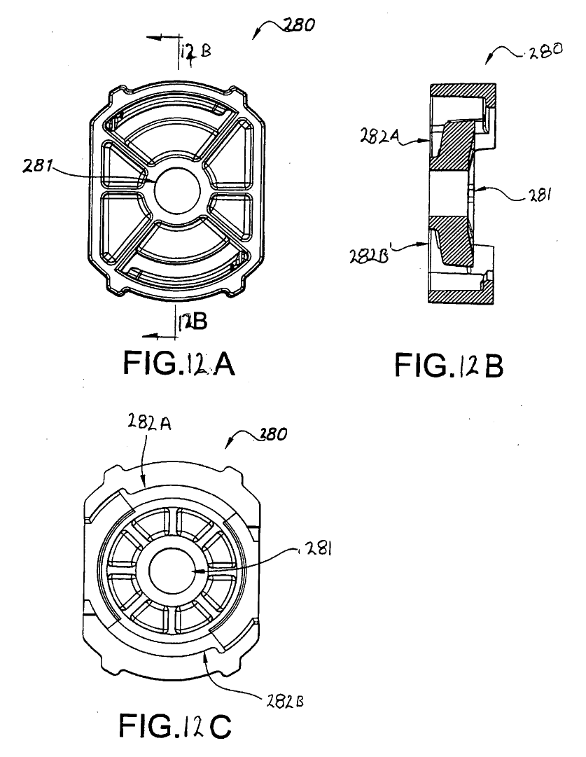

Referring to FIGS. 12A, 12B, and 12C provide respectively a top, sectional, bottom, and perspective view of retainer 280. Retainer 280 is comprised of aperture 281 and two or more tabs 282A/B that engage two or more corresponding shoulders 204 of valve housing 200, providing a quick release bayonet mounting of retainer 80 with valve housing 200.

According to the illustrated embodiment, aperture 261A of stationary disk 260B is in fluid communication with aperture 292A of seal 290, primary outlet channel 234 and primary outlet 230. Aperture 261B of stationary disk 260B is in fluid communication with aperture 292B of seal 290, secondary inlet channel 254, and secondary inlet 250. Aperture 261C of stationary disk 260B is in fluid communication with aperture 292C of seal 290, and passage 214. In addition, bottom surface 269 of movable disk 260A is in sliding contact with top surface 263 of stationary disk 260B. Outer surface 291 of seal 290 is in sealing contact with inner surface of valve chamber 201.

During operation, tab 271 of valve stem 270 engages slot 265 of movable disk 260A. In addition, protuberance 272 of valve stem 270 engages recess 266 of movable disk 260A. Rotation of shaft 273 by attached knob 35 causes rotation of tab 271 about the central axis of valve stem 270, which results in a rotation of movable disk 260A with respect to stationary disk 260B. Tabs 262 of stationary disk 260B engage with corresponding slots 205 in valve chamber 205, preventing stationary disk 260B from rotating with respect to valve body 212.

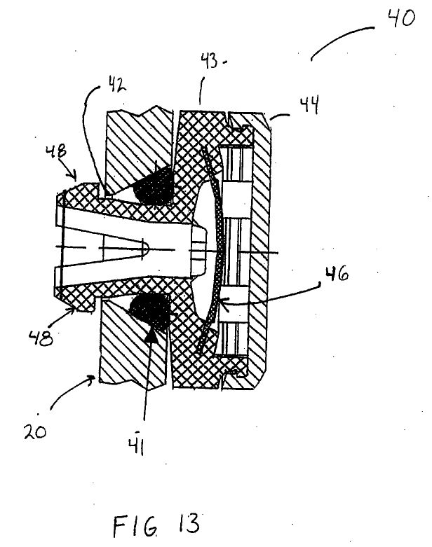

Referring to FIG. 13, top housing vent 40 is shown installed in vent orifice 42 of top housing 20. Gasket 41 is interposed between top housing vent 40 and top housing 20. One skilled in the art would recognize that vent 40 need not necessarily be installed in top housing 20, or that the WTS 10 is limited to only one vent. Vent 40 could be installed anywhere it is desirable to equalize pressure between a portion of the interior of WTS, and ambient pressure. According to the present embodiment, vent 40 is comprised of base 43, membrane 46, and vent cap 44. According to the present embodiment, membrane 46 is comprised of microporous expanded polytetraflouroethylene (“ePTFE”), and is glued, clamped, welded, pressed, or otherwise attached to base 43. Those skilled in the art would recognize that other membranes that are pervious to gas, but impervious to fluids, would function equivalently. According to the illustrated embodiment, tabs 48 of base 43 clip into vent orifice 42. Although shown attached through the wall of top housing 20, base 43 could be welded, glued, or otherwise attached to the WTS. One vent that could be used with WTS 10 is the Gore POV/SNAP-FIT membrane vent PMF100128 by W.L. Gore and Associates of Newark, Del. According to an alternative embodiment, membrane 46 could be glued, clamped, welded, pressed, or otherwise attached directly to the interior or exterior surface of top housing 20 and covering orifice 42. It would be clear to those skilled in the art that one or more membranes 46 could be provided to maintain equal pressures between one or more interior volumes and ambient pressures.

A description of the construction and operation of WTS 10 will now be provided. For illustrative purposes only, WTS 10 will be discussed in the context of a system that treats hot and cold water, and more particularly, water used to treat bath or shower water. According to the illustrated embodiment, sleeve 50 is inserted through the bottom of base 60, with sleeve lip 51 creating a seal between sleeve 50 and base 60. Filter housing 65 is then press-fit into base 60, such that a substantial portion of filter housing 65 is within sleeve 50. Alternatively, filter housing 65 could be glued, welded, threaded, or otherwise attached to base 60.

Filter 67 is removably inserted into filter housing 65, with filter outlet 69 inserted into filter housing outlet 63. Filter housing base 66 is removably attached to filter housing 65. Filter housing base 66 may be press-fit, threadedly connected, or otherwise removably connected with filter housing 65 to allow the removal or replacement of filter 67. Overcap 61 is removably attached to base 60. Overcap 61 may be press-fit or threadedly connected to base 60.

Secondary outlet 240 of valve 55 is coupled with filter housing inlet 64, and secondary inlet 250 coupled with filter housing outlet 63. Top housing 20 is removably pressed onto sleeve 50, with seal 52 interposed between top housing 20 and sleeve 50. Primary outlet 230 is inserted into top housing outlet orifice 70. Nut 71 is threadedly connected to primary outlet 230, with outlet gasket 72 interposed between top housing 20 and nut 71. Primary inlet 220 is inserted into inlet orifice 80. Nut 81 is threadedly connected to primary inlet 220, with outlet gasket 82 interposed between top housing 20 and nut 81.

Battery bracket 94 is electrically coupled with flow sensor meter 256 and connector 93 by wiring harness 100. Battery bracket base 97 is positioned within the hollow interior volume of top housing 20, with gasket 96 forming a seal between surface 88 of battery bracket base 97 and the interior wall of top housing 20. Battery bracket 94 is removably attached to battery bracket base 94 with screws 91. Wires of wiring harness 100 are routed through wire channels 86 into hollow interior volume of top housing 20. Connector 93 is electrically coupled with electronics module 38. It would be obvious to those skilled in the art that battery bracket base 94 could be glued, press-fit, or otherwise attached to top housing 20, or battery bracket base 94 could be formed as an integral part of top housing 20. Battery bracket 94 is adapted to hold one or more batteries (not shown) or other electrical charge storage devices, such as capacitor or super capacitors (not shown).

Valve stem 270 is adapted for insertion through gasket 28, electronics module 38, control panel 30, and knob seal 34. Knob 35 is removably coupled with valve stem 270, with c-clip 32 removably securing knob 35 to valve stem 270.

During operation, fluid and enters valve 55 through primary inlet 220. Valve 55 can be selectively actuated to either direct the flow of water directly to primary outlet 230, bypassing filter 67, hereinafter referred to as “bypass mode”. Alternatively, valve 55 can be actuated to direct fluid entering inlet 220 to the interior of filter housing 65 and through filter 67, hereinafter referred to as “treatment mode”.

During bypass mode, movable disk 260A is rotated by valve stem 270 with respect to stationary disk 260B to a first position, placing primary inlet 220 in fluid communication with primary outlet 230. Fluid travels through primary inlet channel 221, optional flow regulator 222, and passage 214. According to the illustrated embodiment, flow regulator 222 provides a relatively uniform flow rate of between about 1.6 and 2.65 gallons per minute (GPM) across a range of inflow pressures from about 5 to 125 pounds per square inch (PSI). One flow regulator that could be used with diverter valve assembly 10 is the Neoperl Inc. E-NT 58.6273.1 flow regulator, although one skilled in the art would recognize that other flow regulators known in the art could readily be used with the present invention. Fluid then continues sequentially through aperture 292C of seal 290 and aperture 261C of stationary disk 260B, and is diverted by recess 267 of movable disk 260A through aperture 261A. Fluid then passes through aperture 292A of seal 290, primary outlet channel 234, optional check valve 232, and finally through primary outlet 230. According to the illustrated embodiment, optional check valve 232 prevents fluid from entering valve 55 through aperture 230. One check valve that could be used with valve 55 is the Neoperl Inc. OV15 check valve; although one skilled in the art would recognize that other check valves known in the art could readily be used with the present invention.

During treatment mode, movable disk 260A is rotated with respect to stationary disk 260B by valve stem 270 to a second position, such that aperture 361A is in fluid communication with aperture 361B through recess 367. At this orientation, secondary inlet 250 is in fluid communication with primary outlet 230, and primary inlet 220 is not fluid communication with primary outlet 230 as described below. Fluid entering valve 55 at primary inlet 220 travels through primary inlet channel 221 and optional flow regulator 222, across passage 214, through secondary outlet channel 241 and secondary outlet 240, and enters filter housing 65 through inlet orifice 64. Fluid then flows radially inwardly through filter 67, out filter outlet 69, and into secondary inlet 250 of valve 55. Fluid then passes through secondary inlet channel 254 and optional flow meter 252. Flow meter 252 is magnetically coupled with flow meter sensor 256 to generate a signal as fluid flows through flow meter 252. This signal can be used to determine the flow volume through secondary inlet 250 using methods known in the art. One embodiment of an inline flow meter magnetically coupled to a sensor that could be used with valve 55 is shown and described in U.S. Pat. No. 5,876,610 to Clack et al., the subject matter of which is incorporated by reference.

After passing through flow meter 252, fluid then passes through aperture 290B of seal 290, and then through aperture 361B of stationary disk 260B and is diverted by recess 267 of movable disk 260A to aperture 261A. Fluid then passes through aperture 290A of seal 290, primary outlet channel 234, optional check valve 232, and primary outlet 230.

According to one embodiment, recess 267 of movable disk 260A is adapted to provide fluid communication between apertures 261A, 261B, and 261C as movable disk 260A transitions from the first position to the second position as described above. This embodiment can help prevent a build-up of pressure within filter housing 65 by ensuring that the secondary inlet 250 is not isolated from primary outlet 230 until after primary inlet 220 is in fluid communication with primary outlet 230.

Sleeve 50, overcap 61, and top housing 20, comprise an exterior housing of WTS 10, which substantially contains and isolates the components of WTS 10 from the surrounding environment. In particular, the exterior housing of WTS 10 protects the interior components from unwanted moisture, dust, dirt, and other contaminants. The hollow interior volume of top housing 20 is adapted to substantially contain electrical components of WTS 10, such as battery bracket 94, wiring harness 100, electrical connector 93, flow meter sensor 256, and electronics module 38. Filter housing 65, filter housing base 66, and optional valve 55 comprise a closed fluid treatment subassembly contained within the exterior housing of WTS 10 and adapted to fluidly isolate moisture-sensitive components of WTS 10 from the fluid treated by WTS 10, and more particularly isolate the battery housing 97, electronics module 38, wiring harness 94, and any other moisture-sensitive components within WTS 10 from the fluid being treated by WTS 10. Battery housing vent orifice 98 is adapted to enable the equalization of pressure between the interior of battery housing 90 with the interior of top housing 20. Battery housing vent 45 is adapted to prevent moisture and other contaminants from traveling though battery housing vent 98, and in particular, to substantially prevent moisture from entering battery housing 90 from the interior of top housing 20. Vent orifice 42 is adapted to enable the equalization of pressure between the interior of top housing 20 with the ambient pressure of the environment surrounding WTS 10. Top housing vent 40 is adapted to substantially prevent moisture and other contaminants from entering top housing 20 from the environment surrounding WTS 10.

According to the illustrated embodiment, WTS 10 is adapted to treat water of varying temperatures. For example, the illustrated embodiment may be used to treat bath water, which may range between 40 and 140 degrees Fahrenheit (4.4-60 degrees Celsius). As WTS 10 heats and cools, and the components and gasses within top housing 20 and battery housing 90 expand and contract. Top housing vent 40 substantially prevents moisture from entering top housing 20 from the surrounding environment as the pressure within top housing 20 equalizes with the surrounding ambient pressure. Similarly, battery housing vent 45 prevents moisture and other contaminants from entering battery housing 90 from top housing 20 as the pressure within battery housing 90 equalizes with the pressure within top housing 20.

While in the foregoing specification this invention has been described in relation to certain preferred embodiments thereof, and many details have been set forth for the purpose of illustration, it will be apparent to those skilled in the art that the invention is susceptible to alteration and that certain other details described herein can vary considerably without departing from the basic principles of the invention.

1. A fluid treatment system comprising:
an exterior housing having an interior volume;
an electronics module substantially contained within the interior volume of the exterior housing;
a filter housing substantially contained within the exterior housing and adapted to fluidly isolate the electronics module from the fluid treated by the fluid treatment system; and
a vent; wherein the vent is adapted to substantially equalizes the pressure between the interior volume of the exterior housing and an ambient pressure, and wherein the vent is further adapted to substantially prevent fluid from entering the interior volume of the exterior housing from an ambient environment.

2. The fluid treatment system of claim 1, wherein the electronics module is adapted to monitor the volume of fluid treated by the fluid treatment system.

3. The fluid treatment system of claim 1, wherein the electronics module is adapted to monitor the time that the fluid treatment system is in use.

4. The fluid treatment system of claim 1, wherein the vent is comprised of microporous expanded polytetraflouroethylene.

5. The fluid treatment system of claim 1 further comprising a valve in fluid communication with the filter housing and substantially contained within the interior volume of the exterior housing.

6. The fluid treatment system of claim 5, wherein the valve is adapted to selectively direct fluid entering the fluid treatment system to either flow into the filter housing or to bypass the filter housing.

7. The fluid treatment system of claim 6, wherein the valve is comprised of a valve body and a flow regulator disposed at least partially within the valve body.

8. The fluid treatment system of claim 7, wherein the valve further comprises a flow meter disposed at least partially within the valve body.

9. The fluid treatment system of claim 8, wherein the valve further comprises a check valve disposed at least partially within the valve body.

10. A fluid treatment system comprising:
an exterior housing having an interior volume;
a battery housing substantially contained within the interior volume of the exterior housing;
a filter housing substantially contained within the exterior housing and adapted to fluidly isolate the battery housing from the fluid treated by the fluid treatment system; and
a vent; wherein the vent is adapted to substantially equalizes the pressure between the interior volume of the battery housing and an ambient pressure, and wherein the vent is further adapted to substantially prevent fluid from entering the interior volume of the battery housing from an ambient environment.

11. The fluid treatment system of claim 10, further comprising a battery bracket disposed at least partially within an interior volume of the battery housing.

12. The fluid treatment system of claim 11 further comprising an electronics module.

13. The fluid treatment system of claim 12, further comprising a wiring harness electrically coupled with the electronics module and the battery bracket.

14. The fluid treatment system of claim 13, wherein the electronics module is adapted to monitor and display information about the fluid treatment system.

15. The fluid treatment system of claim 14, wherein wherein the vent is comprised of microporous expanded polytetraflouroethylene.

16. A fluid treatment system comprising:
an exterior housing having a top housing and an interior volume;
an electronics module substantially supported by the top housing and contained within the interior volume of the top housing;
a battery housing supported by the top housing and substantially contained within the interior volume of the exterior housing;
a filter housing substantially contained within the exterior housing and adapted to fluidly isolate the electronics module and the battery housing from the fluid treated by the fluid treatment system;
a first vent; wherein the first vent is adapted to substantially equalizes the pressure between the interior volume of the battery housing and the interior volume of the top housing, and wherein the vent is further adapted to substantially prevent fluid from entering the interior volume of the battery housing from the interior volume of the top housing; and
a second vent adapted to substantially equalizes the pressure between the interior volume of the top housing and an ambient pressure, and wherein the vent is further adapted to substantially prevent fluid from entering the interior volume of the top housing from an ambient environment.

17. The fluid treatment system of claim 16, wherein the first and second vents are comprised of microporous expanded polytetraflouroethylene.

18. The fluid treatment system of claim 17, wherein the electronics module is adapted to monitor and display information about the fluid treatment system.

19. A method of manufacturing a fluid treatment system comprising the steps of:
providing an electronics module;
providing a filter housing adapted for fluid communication with a fluid supply system, and further adapted to fluidly isolate the fluid supply system from the electronics module; and
substantially containing the electronics module and the filter housing within an interior volume of an exterior housing;
whereby the exterior housing is comprised of a vent adapted to equalizes the pressure between the interior volume of the exterior housing and an ambient pressure, and whereby the vent is further adapted to substantially prevent moisture from entering the interior volume of the top housing from an ambient environment.

20. A point-of-use water treatment system comprising:
a filter housing;
an electronics module fluidly isolated from the filter housing;
a top housing supporting the electronics module;
a vent transversing a wall of the top housing and an ambient environment;
wherein the top housing is barometrically affected by the physical characteristics of the fluid, and wherein the vent facilitates the equalization of pressure between the interior of the top housing and the ambient environment while substantially preventing fluid from entering the interior of the top housing from the ambient environment.
